(19) United States
(12) Patent Application Publication
(10) Pub. No.: US 2022/0299445 A1
(43) Pub. Date: Sep. 22, 2022

(54) Screening Test Paper Reading System

(71) Applicant: Cheng-Hao KO, Hsinchu County (TW)

(72) Inventor: Cheng-Hao KO, Hsinchu County (TW)

(21) Appl. No.: 17/263,551

(22) PCT Filed: Aug. 20, 2020
(86) PCT No.: PCT/CN2020/110228

§ 371 Date: Jan. 27, 2021

(51) Int. Cl. G01N 21/78; G01N 21/01; G01N 21/84

(52) U.S. Cl. CPC G01N 21/78; G01N 21/01; G01N 21/8483; G01N 2021/0106

(57) ABSTRACT

A screening test paper reading system includes a reading and light illumination unit which has a reading device and a light illumination device, a screening test paper having a reaction zone arranged thereon for reacting chemically with a number of specific specimens and change its color accordingly, an optical analyzing unit connected to the reading and light illumination unit, and analyzing spectrum signals of a screened line image received from a reaction zone on a screening test paper. Notably, the reading device reads spectrum signals of an reflected image from the screened line after illuminated in the reaction zone and then transmits the spectrum signals of the reflected image subsequently to the optical analyzing unit for computing and analyzing.

### BACKGROUND OF THE PRESENT INVENTION

### Field of Invention

This invention generally relates to a screening test paper reading system, especially to a screening test paper reading system capable of achieving a fast-track screening of Covid-19 and effects of conducting a fast track screening and a subsequent screening rapidly by replacing a new screening test paper.

### Description of Related Arts

As people pay more and more attention to their health, screening, including physical screening or environmental screening, has become an extremely hot topic. FIG. 1 is a schematic view of a conventional screening test paper, wherein a reaction zone 81 is provided on the screening test paper 80. When a user drops a specimen on the reaction zone 81, the reaction zone 81 reacts chemically with the specimen and the color of the reaction zone 81 changes accordingly. The user therefore is able to determine whether the specimen falls within the normal range based on the color change and the degree of the color contrast. However, the accuracy on determining color change observed by human's eyes is poor, and it might lead to a result of false negative. Notably, the recent outbreak of the coronavirus pandemic has impacted the world economics, transportation and daily life enormously; the governments, research organizations and industries around the world are aggressively putting great efforts and resources into research and develop for a fast-track screening for Covid-19. It has been known that fast-track screening test papers are used to conduct a rapid screening, and a re-screening with a higher precision will be performed once a possible case has been detected during the first screening for further confirmation, therefore, a screening with high precision is performed which spectrum analyzers is applied most of the time.

As described in Taiwan Patent No. TWI612306, a portable point of care Testing (POCT) system including an in vitro detection device and an electronic device was disclosed. The in vitro detection device contains a closed space to receive a strip box, a camera module, and a Bluetooth (BT) module. The strip box is provided with a test paper inside for the test, the camera module is used to fetch images of the test paper while the Bluetooth (BT) module transmits the images fetched to the electronic device. The electronic device is provided with a piece of an analysis software, which is used to compare the images received from the Bluetooth (BT) module with the data downloaded from a cloud system, and to produce a test report on the physiological response and its intensity for the person under test, so as to achieve the purpose of early detection and early diagnosis. It has been noticed that the prior art uses image recognition technique to perform screening, and it might lead to a result of false negative due to an inconclusive outcome of the screened image.

As described in China Patent No. CN104020286, an immunochromatography quantitative detection instrument and a detection method of colloidal gold, latex and the like for quantitative detection of an immunochromatography test strip are disclosed. A to-be-detected sample can be dripped onto a transverse immunochromatography test strip which is marked in advance to coat a corresponding antigen-antibody, then the test strip will be inserted into a detection tank of the immunochromatography quantitative detection instrument which is used for confirming the color chromaticity and background chromaticity of C and T line regional positions in a nitrocellulose membrane of the test strip by virtue of multi-wavelength scanning. The identification computational analysis is performed on optical density values of a quality control band and a detection band according to a built-in algorithm of the instrument, so that the concentration of positive markers contained in the to-be-detected sample can be obtained. Then, a report is printed and a result value is stored. It has been noticed that the prior art uses multi-wavelength scanning, multi-wavelength scanning color hue and background hue to perform screening, which does not use a spectrum analyzer for screening and is less precise.

However, if using a spectrum analyzer for screening, the users have to place a screening test paper on a corresponding position manually so as to enable the spectrum analyzer to retrieve a color signal from the reaction zone, which may cause the screening test paper wearing and lead easily to a problem that the color signal cannot be retrieved due to the inaccurate placement. Consequently, it is time-consuming in adjusting the position of the screening test paper, therefore, it is far from being practical. With the above object in view, one embodiment in the present invention discloses a screening test paper reading system, which comprises a reading and light illumination unit having a reading device and a light illumination device, wherein the reading and light illumination unit uses an optical analyzing unit, which is connected to the reading and light illumination unit, to analyze spectrum signals of a screened line image received from a reaction zone in a screening test paper on the reading device, so as to precisely screen a to-be-screened object on the test paper.

### SUMMARY OF THE PRESENT INVENTION

One object of the invention is to provide a screening test paper reading system, which is capable of achieving effects of conducting a fast track screening and a subsequent screening rapidly by replacing a new screening test paper.

Anther object of the invention is to provide a screening test paper reading system using an image enlarger, which enlarges spectrum signals of a reflected image reflected by a radiated light towards to-be-screened lines on the reaction zone, thereby enabling a more precise screening to be performed on the screening paper with spectrum signals.

The present invention discloses a screening test paper reading system, comprising: a reading and light illumination unit, which has a reading device and a light illumination device; a screening test paper, which has a reaction zone arranged thereon, wherein the reaction zone is able to react chemically with a number of specific specimens and change its color accordingly; an optical analyzing unit, which is connected to the reading and light illumination unit, analyzing spectrum signals of a screened line image received from the reaction zone on a screening test paper; a test paper carrier, which has a bearing groove arranged thereon for accommodating the screen test paper, wherein the screen test paper is affixed onto the test paper carrier, and a linking member also arranged on the test paper carrier; a moving and carrier platform unit, which has a moving platform, a driving device and a carrier base, wherein the carrier base is adapted for carrying the reading and light illumination unit, the test paper carrier, the moving platform and the driving device, wherein the driving device is connected with a linking member for operation; and a circuit board unit, which is electrically connected between the reading and light illumination unit, the optical analyzing unit, and the moving and carrier platform unit, used for processing circuit signals received from the aforementioned units, wherein the test paper carrier for screening papers is connected and placed onto the moving platform, wherein when a screening paper is placed onto the bearing groove of the test paper carrier, and the test paper carrier moves to a reading position in the reading and light illumination unit, the light illumination device radiates light to the screening paper, the reading device reads spectrum signals of an reflected image from the screened line after it has been illuminated in the reaction zone, and transmits the spectrum signals of the reflected image subsequently to the optical analyzing unit for computing and analyzing.

According to the aforementioned screening test paper reading system, the moving and carrier platform unit comprises a position sensor that is adapted for sensing a relative position of the moving and carrier platform unit.

According to the aforementioned screening test paper reading system, the driving device is a stepper motor.

According to the aforementioned screening test paper reading system, the linking member is a gear rack.

According to the aforementioned screening test paper reading system, the screening test paper is for specific specimens selected from the group consisting of saliva, urine, blood, excrement, water, food, toxic and hazardous substance, microorganism, and combinations thereof.

According to the aforementioned screening test paper reading system, the screening test paper is a screening test paper for Covid-19 IgM/IgG Rapid Test Kit, an immunochromatography test paper, a biological fast-track screening test paper or an immunity antibody fast-track screening test paper.

According to the aforementioned screening test paper reading system, the light illumination device is selected from the group consisting of white LEDs, UV LEDs, NIR LEDs, laser diodes, halogen lamps, tungsten lamps, and combinations thereof.

According to the aforementioned screening test paper reading system, the optical analyzing unit is an optical wavelength spectrometer or a spectrum analyzer.

According to the aforementioned screening test paper reading system, the reading device further includes an image enlarger, which enlarges spectrum signals of a reflected image reflected by a radiated light towards to-be-screened lines on the reaction zone.

According to the aforementioned screening test paper reading system, the image enlarger is made of a magnifying lens and a refractive lens.

According to the aforementioned screening test paper reading system, the magnification of the image enlarger ranges between 1.5 and 10 times.

According to the aforementioned screening test paper reading system, the screening lines is IgM or IgG.

According to the aforementioned screening test paper reading system, the moving platform further includes a linear guide that is adapted for facilitating the moving platform to move.

According to the aforementioned screening test paper reading system, the moving and carrier platform unit further includes at least one caging device, which is a photo interrupter.

According to the aforementioned screening test paper reading system, the system further includes a holding seat, which is adapted for carrying the reading and light illumination unit and the optical analyzing unit.

According to the aforementioned screening test paper reading system, the holding seat further includes a supportive rod, which is adapted for connecting the holding seat and a carrier base.

According to the aforementioned screening test paper reading system, the driving device further includes a motor holding seat, which is adapted for carrying the stepper motor and connecting it to be fixed onto the carrier base.

According to the aforementioned screening test paper reading system, the linear guide further includes a holding seat for the linear guide, which is adapted for securing the moving platform onto the carrier base.

### BRIEF DESCRIPTION OF THE DRAWINGS

FIG. 1 is a schematic view of a conventional screening test paper according to PRIOR ART.

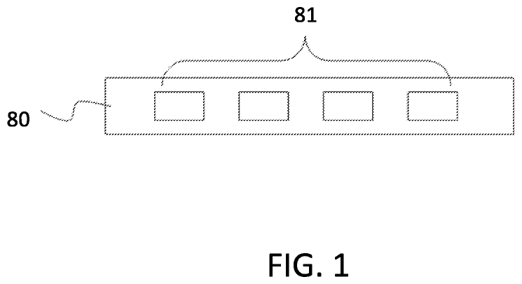

FIG. 2 is a 3D structural breakdown view of the screening test paper reading system according to the present invention.

FIG. 3 is a structural breakdown at lateral view of the screening test paper reading system according to the present invention.

FIG. 4 is a front view of the screening test paper reading system according to the present invention.

FIG. 5 is a rear view of the screening test paper reading system according to the present invention.

FIG. 6 is a top view of the screening test paper reading system according to the present invention.

FIG. 7 is an enlargement of the image enlarger in the screening test paper reading system according to the present invention.

FIG. 8 is a schematic diagram of reading signals by the image enlarger in the screening test paper reading system according to the present invention.

### DETAILED DESCRIPTION OF THE PREFERRED EMBODIMENT

Some terms are used to refer to specific components in the specification and subsequent claims. However, it is to be understood by a person having ordinary skill in the art that the hardware manufacturers may use different terms to describe the same component. The components in the specification and subsequent claims are not distinguished by their names, but by the difference in the function. The term “comprising” throughout the specification and subsequent claims is an open-ended term, so the term “comprising” is to be construed as “comprising, but not limited to”.

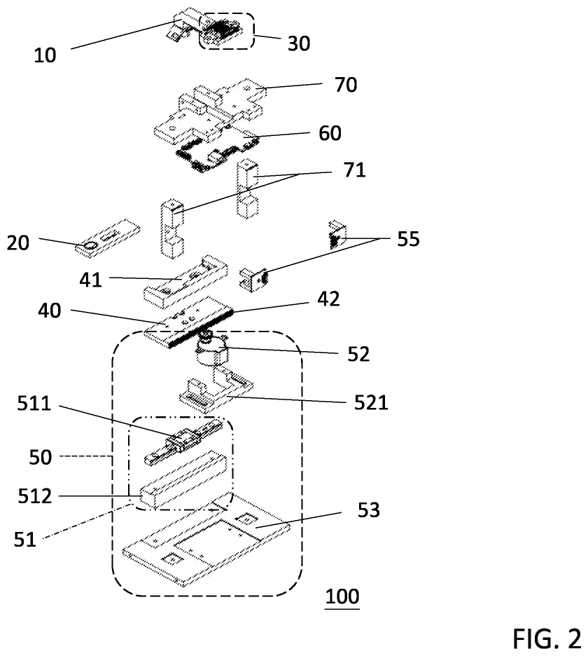

From FIGS. 2 to 8, a 3D structural breakdown view of the screening test paper reading system, a structural breakdown at lateral view of the screening test paper reading system, a partial enlargement view of the image enlarger according to the present invention are disclosed respectively. As shown in FIG. 2, the screening test paper reading system 100 of the invention comprises a screening test paper 20, a test paper carrier 40, a reading and light illumination unit 10, a moving and carrier platform unit 50, and a circuit board unit 60. Also shown in FIG. 2, another embodiment disclosed in the invention is a screening test paper reading system, which comprises: a reading and light illumination unit 10 having a reading device 11 and a light illumination device 12, which is used for reading and light illuminating; a screening test paper 20 provided with a reaction zone, wherein the reaction zone reacts chemically with a plurality of specific samples (e.g., urine, blood, and etc.), and changes its line color after the chemical reaction accordingly; the screening test paper is a screening test paper for Covid-19 IgM/IgG Rapid Test Kit, which is able to rapidly run a screening on Covid-19; an optical analyzing unit 30, which is connected to the reading and light illumination unit 10 and is a micro-spectrum analyzer, is adapted for analyzing spectrum signals of a screened line image received by the reading device 11 from the reaction zone on a screening test paper; a test paper carrier 40, which has a bearing groove 41 arranged thereon for accommodating the screen test paper 20, wherein the screen test paper 20 is affixed onto the test paper carrier 40, and a linking member 42 which is a gear rack also arranged on the test paper carrier 40; a moving and carrier platform unit 50, which has a moving platform 51, a driving device 52 and a carrier base 53, wherein the carrier base 53 is adapted for carrying the reading and light illumination unit 10, the test paper carrier 40, the moving platform 51 and the driving device 52. Notably, the driving device 52 is a stepper motor. In addition, the driving device 52 (stepper motor) is mechanically connected to a linking member 42 (gear rack) for activation, so as to move the moving platform 51; and a circuit board unit 60, which is electrically connected between the reading and light illumination unit 10, the optical analyzing unit 30, and the moving and carrier platform unit 50, adapted for processing circuit signals received from the aforementioned units. When the carrier platform unit 40 is connected and placed onto the moving platform 51, and a screening paper 20 is placed onto the bearing groove 41 of the screening paper carrier platform unit 40, the driving device 52 is activated and moves the moving platform 51 through a linking member 42, and when the screening paper carrier platform unit 40 moves to a reading position in the reading and light illumination unit 10, the light illumination device 12 that is a white LED irradiates light to the screening paper 20, and then the reading device 11 reads spectrum signals of an reflected image from the screened line after it has been illuminated in the reaction zone, and then transmits the spectrum signals of the reflected image subsequently to the optical analyzing unit 30 for computing and analyzing. The screening test paper as disclosed above is for specific specimens selected from the group consisting of saliva, urine, blood, excrement, water, food, toxic and hazardous substance, microorganism, and combinations thereof. Additionally, the screening test paper disclosed in the above embodiment can be substituted for a Covid-19 IgM/IgG Rapid Test Kit, an immunochromatography test paper, a biological fast-track screening test paper or an immunity antibody fast-track screening test paper, and the light illumination device disclosed in the above embodiment can be substituted for an UV LED, a NIR LED, a laser diode, a halogen lamp, or a tungsten lamp. Moreover, the optical analyzing unit can be substituted for an optical wavelength spectrometer.

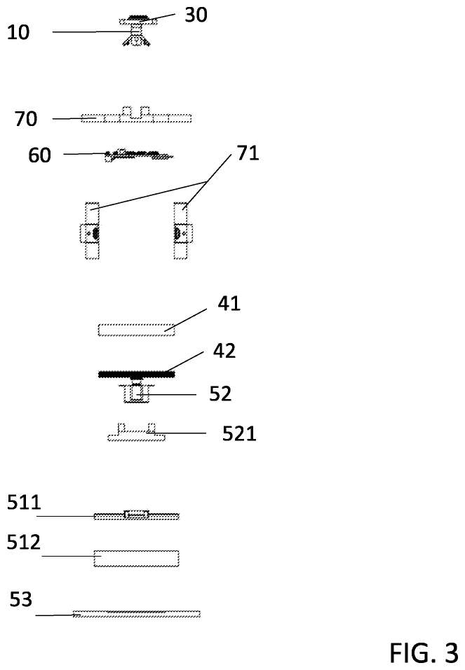

As shown in FIG. 3, a structural breakdown at lateral view of the screening test paper reading system according to the present invention is illustrated, wherein the screening test paper reading system 100 further includes a holding seat 70, which is adapted for carrying the reading and light illumination unit 10 and the optical analyzing unit 30, and the holding seat 70 further includes a supportive rod 71 for connecting the holding seat 70 and a carrier base 53. The driving device 52 further includes a motor holding seat 521, which is adapted for holding the stepper motor and connects and secures it to the carrier base 53. In addition, the moving platform 51 further includes a linear guide 511, which is adapted for sliding the moving platform 51, wherein the linear guide 511 further includes a holding seat 512 for the linear guide 511, which is adapted for securing the moving platform 51 onto the carrier base 53.

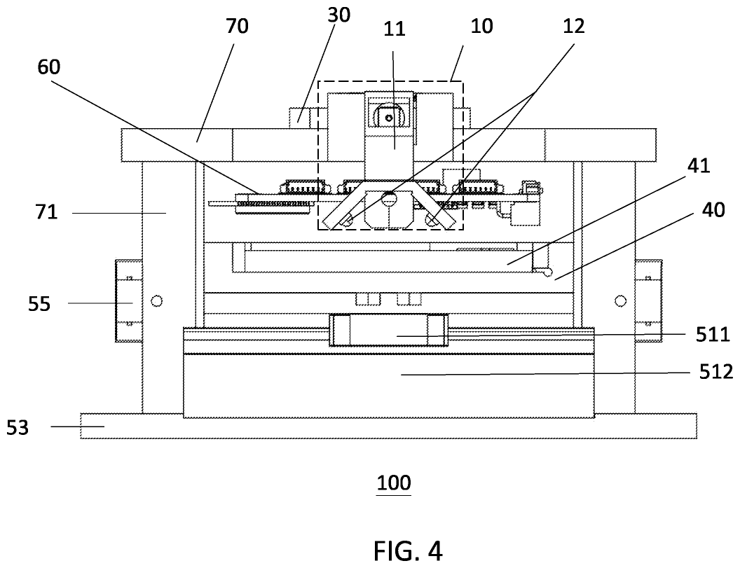

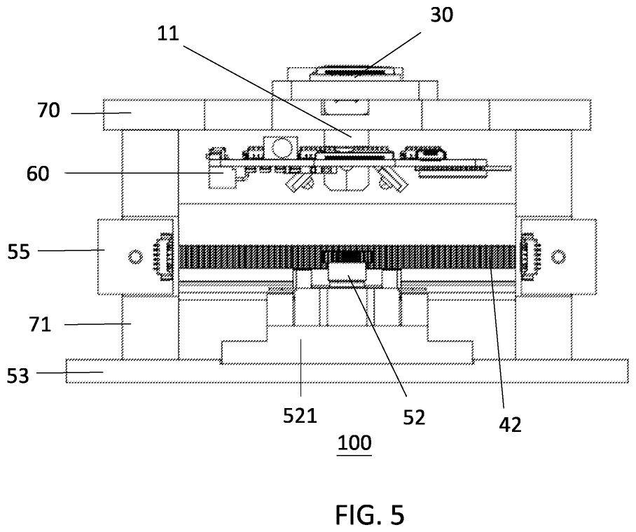

As shown in FIGS. 4 and 5, a front view of the screening test paper reading system and a rear view of the screening test paper reading system according to the present invention are illustrated, when a screening test paper 20 is placed onto the bearing groove 41 in the screening test paper carrier 40, the driving device (stepper motor) 52 of the screening test paper reading system is activated, because the driving device 52 is mechanically connected with the linking member (gear rack) 42 for activation (as shown in FIG. 5); and when the test paper carrier 40 is connected and placed onto the moving platform 51, the driving device 52 will drive the linking member 42 in order to move the moving platform 51, and then run a zone verification on the screening test paper. Notably, the moving and carrier platform unit 50 further includes a position sensor 55, which is adapted for sensing a relative position of the moving and carrier platform unit 50. In addition, the moving and carrier platform unit 50 further includes at least one casing device, which is a photo interrupter (not shown). The position sensor 55 reads position to compute and locate relative positions of the casing device and the test paper carrier 40, so as to move the test paper carrier 40 to a reading position required by the reading and light illumination unit 10.

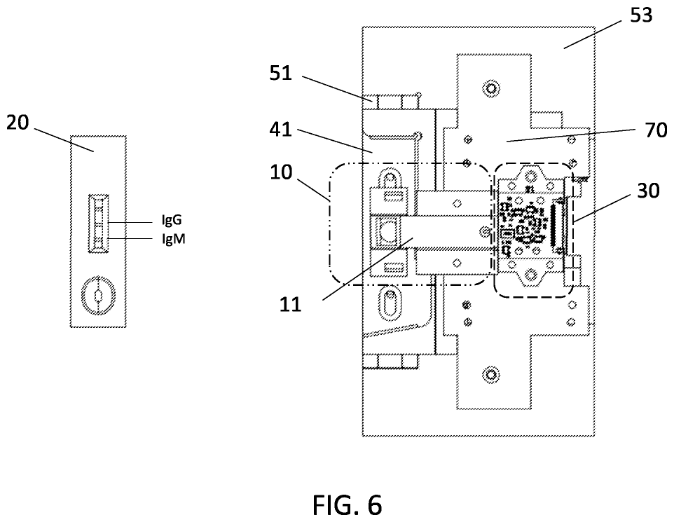

As disclosed in the aforementioned embodiment, an example has been disclosed that when using a value of glycosuria inspected from a patient as the target for screening test paper, the screening test paper needs to be confirmed for glycosuria use only, so that the screening can be run directly, that is, to place the urine specimen on the screening test paper 20 for reaction (usually in a form of drip or infiltration), and the component in the reaction zone reacts chemically with the urine and changes its color accordingly. In addition, the reaction zone may contain a variety of inspection zones to inspect glucose, protein, pH value, latent blood value or other physiological values in urine, thereby achieving a multiple inspection with one screening. Once the urine is placed to the reaction zone for reaction, a screening paper 20 is placed onto the bearing groove 41 of the screening paper carrier platform unit 40, the optical analyzing unit 30 has the reading device 11 read spectrum signals of an reflected image from the screened line after it has been illuminated in the reaction zone, and then has it transmitted the spectrum signals of the reflected image subsequently to the optical analyzing unit 30 for computing and analyzing. As shown in FIG. 6, the screening test paper 20 can be substituted for Covid-19 IgM/IgG Rapid Test Kit, wherein the screening lines may be IgM or IgG, which is able to run a rapid screening on Covid-19. Additionally, the present invention is able to accurately measure the reacted spectrum signals of the to-be-screened object, to run a rapid screening and replace a fast-track screening paper, and to solve the problem of false negative due to erroneous judgment of lines.

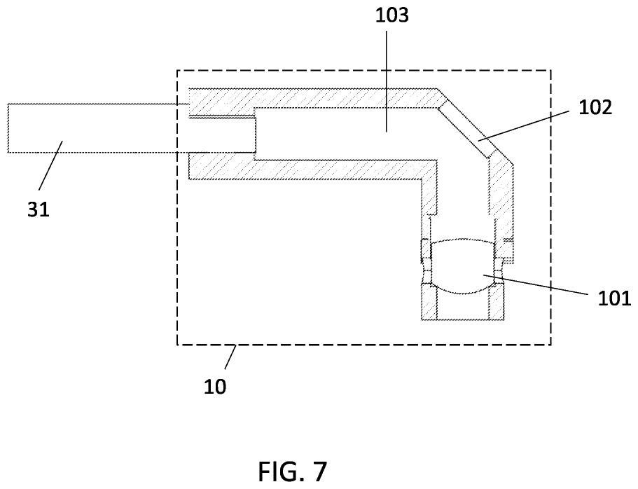

As disclosed in the aforementioned embodiment, the screening test paper reading system has the reading device 11, which further includes an image enlarger for enlarging spectrum signals of a reflected image reflected by a radiated light towards to-be-screened lines on the reaction zone. As shown in FIG. 7, the image enlarger is made of a magnifying lens 101 and a refractive lens 102, wherein the magnification of the image enlarger ranges between 1.5 and 10 times. When the reading device 11 reads spectrum signals of an reflected image from the screened line after it has been illuminated in the reaction zone, the spectrum signals of the reflected image will first pass through the magnifying lens 101, the refractive lens 102 and photo transceiver passage 103, so as to magnify the signals and transmit it to a reading head 31 of the optical analyzing unit 30 for subsequent optical analyzing.

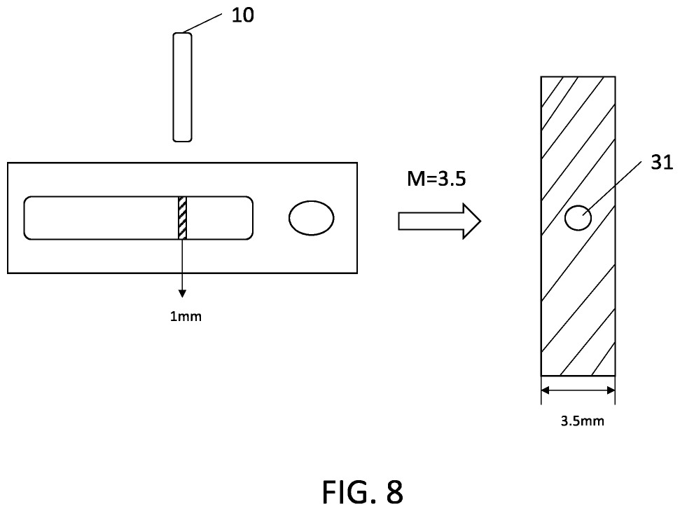

As shown in FIG. 8, when the reading device 11 reads spectrum signals of an reflected image from the screened line after it has been illuminated in the reaction zone, and the selected image enlarger sets its magnification to 3.5 times, then the reflected image of original read screening lines will be enlarged based on the set magnification. That is, when the width of the reflected image is 1mm, an image of 3.5mm signal will be received by the reading head 31 of the optical analyzing unit 30 after the enlargement, and subsequently, the optical analyzing unit 30 runs analysis on the received enlarged signal. The aforementioned device is able to prevent users from a failure of retrieving color, unclear lines or a false negative in screened lines, which may be caused by a bad contact reaction with the object to-be-screened when using a screening test paper for Covid-19 IgM/IgG Rapid Test Kit, an immunochromatography test paper, a biological fast-track screening test paper or an immunity antibody fast-track screening test paper, and lead to an erroneous judgment during screening.

As disclosed in the aforementioned embodiments, the present invention is able to solve the problem in finding an erroneous judgment that leads to a false negative outcome. Moreover, users are able to replace screening test paper 20 on the screening carrier unit 40 in a short period of time, so as to achieve a goal for repetitive screening.

It is to be understood by those of ordinary skill in the art that the above preferable embodiments of the invention are described in detail and the various possible modifications and alterations of the embodiments could be made, without departing from the scope and spirit of the invention. The various embodiments such as “caging” are not limited by the way carrying out the embodiments in the specification.

What is claimed is:

1. A screening test paper reading system, comprising:
a reading and light illumination unit having a reading device and a light illumination device;
a screening test paper having a reaction zone arranged thereon, wherein the reaction zone reacts chemically with a number of specific specimens and changes its color of lines in the reaction zone accordingly;
an optical analyzing unit, which is connected to the reading and light illumination unit, adapted for analyzing spectrum signals of a screened line image received from a reaction zone on a screening test paper;
a test paper carrier having a bearing groove arranged thereon, adapted for accommodating the screening test paper and fixing the screening test paper on the test paper carrier, and a linking member also arranged thereon as well;
a moving and carrier platform unit, which has a moving platform, a driving device and a carrier base, wherein the carrier base is adapted for carrying the reading and light illumination unit, the test paper carrier, the moving platform and the driving device, wherein the driving device is connected with the linking member; and
a circuit board unit, which is electrically connected between the reading and light illumination unit, the optical analyzing unit, and the moving and carrier platform unit, adapted for processing circuit signals received from the aforementioned units, wherein the test paper carrier for screening papers is connected and placed onto the moving platform, when a screening paper is placed onto the bearing groove of the test paper carrier, and the test paper carrier moves to a reading position in the reading and light illumination unit, the light illumination device radiates light to the screening paper, and the reading device reads spectrum signals of an reflected image from the screened line illuminated in the reaction zone, and then transmits the spectrum signals of the reflected image subsequently to the optical analyzing unit for computing and analyzing.

2. The screening test paper reading system, as recited in claim 1, wherein the moving and carrier platform unit further comprises a position sensor which is adapted for sensing a relative position of the moving and carrier platform unit.

3. The screening test paper reading system, as recited in claim 1, wherein the driving device is a stepper motor.

4. The screening test paper reading system, as recited in claim 1, wherein the linking member is a gear rack.

5. The screening test paper reading system, as recited in claim 1, wherein the screening test paper is for specific specimens selected from the group consisting of saliva, urine, blood, excrement, water, food, toxic and hazardous substance, microorganism, and combinations thereof.

6. The screening test paper reading system, as recited in claim 1, wherein the screening test paper is a screening test paper for Covid-19 IgM/IgG Rapid Test Kit, an immunochromatography test paper, a biological fast-track screening test paper or an immunity antibody fast-track screening test paper.

7. The screening test paper reading system, as recited in claim 1, wherein the light illumination device is selected from the group consisting of white LEDs, UV LEDs, NIR LEDs, laser diodes, halogen lamps, tungsten lamps, and combinations thereof.

8. The screening test paper reading system, as recited in claim 1, wherein the optical analyzing unit is an optical wavelength spectrometer or a spectrum analyzer.

9. The screening test paper reading system, as recited in claim 1, wherein the reading device further comprises an image enlarger which enlarges spectrum signals of a reflected image reflected by a radiated light towards to-be-screened lines on the reaction zone.

10. The screening test paper reading system, as recited in claim 9, wherein the image enlarger is made of a magnifying lens and a refractive lens.

11. The screening test paper reading system, as recited in claim 10, wherein the magnification of the image enlarger ranges between 1.5 and 10 times.

12. The screening test paper reading system, as recited in claim 1, wherein the screening lines is IgM or IgG.

13. The screening test paper reading system, as recited in claim 1, wherein the moving platform further comprises a linear guide which is adapted for sliding the moving platform.

14. The screening test paper reading system, as recited in claim 2, wherein the moving and carrier platform unit further comprises at least one casing device which is a photo interrupter.

15. The screening test paper reading system, as recited in claim 1, further comprising a holding seat, which is adapted for carrying the reading and light illumination unit and the optical analyzing unit.

16. The screening test paper reading system, as recited in claim 15, wherein the holding seat further comprises a supportive rod which is adapted for connecting the holding seat and a carrier base.

17. The screening test paper reading system, as recited in claim 3, the driving device further comprises a motor holding seat which is adapted for carrying the stepper motor and affxing the stepper motor onto the carrier base.

18. The screening test paper reading system, as recited in claim 13, wherein the linear guide further comprises a holding seat for the linear guide which is adapted for securing the moving platform onto the carrier base.
